(19) United States
(12) Patent Application Publication
(10) Pub. No.: US 2011/0300449 A1
(43) Pub. Date: Dec. 8, 2011

(54) Electrode for secondary power source and method of manufacturing electrode for secondary power source

(75) Inventors: Hak Kwan Kim, Hanam (KR); Dong Hyeok Choi, Suwon (KR); Hong Seok Min, Yongin (KR); Bae Kyun Kim, Seongnam (KR); Hyun Chul Jung, Yongin (KR)

(73) Assignee: SAMSUNG ELECTRO-MECHANICS CO., LTD., Suwon (KR)

(21) Appl. No.: 12/923,900

(22) Filed: Oct. 13, 2010

(30) Foreign Application Priority Data
Jun. 8, 2010 (KR) 10-2010-0054005
Aug. 2, 2010 (KR) 10-2010-0074733
Aug. 2, 2010 (KR) 10-2010-0074772

(51) Int. Cl. H01M 4/13; B05D 5/12; H01G 9/00

(52) U.S. Cl. 429/231.95; 361/502; 427/8

(57) ABSTRACT

Provided are a method of manufacturing an electrode for a secondary power source, and a secondary power source. The method includes forming an electrode active material on a conductive sheet, forming a Li thin film layer by depositing lithium (Li) on the electrode active material, doping the electrode active material with the deposited Li, and controlling a doping level by monitoring the doping amount of Li. Accordingly, a cathode is doped with Li ions before a cell is assembled, thereby simplifying the manufacturing process, enhancing the doping rate of Li ions, and making the doping amount even.

### CROSS-REFERENCE TO RELATED APPLICATIONS

This application claims the priority of Korean Patent Application Nos. 10-2010-0054005 filed on Jun. 8, 2010, 10-2010-0074733 filed on Aug. 2, 2010 and 10-2010-0074772 filed on Aug. 2, 2010 in the Korean Intellectual Property Office, the disclosures of which are incorporated herein by reference.

### BACKGROUND OF THE INVENTION

1. Field of the Invention

The present invention relates to an electrode for a secondary power source, and a method of manufacturing an electrode for a secondary power source, and more particularly, to a method of manufacturing an electrode for a secondary power source, which can simplify the manufacturing process by increasing the doping rate of lithium (Li) ions.

2. Description of the Related Art

The development of electric vehicles (EV) or hybrid electric vehicles (HEV), employing both an engine and a motor, has led to the development of new energy storage systems satisfying desired energy capacity and output for better energy efficiency. Notably, a secondary power source, such as a Ni-MH battery, a Li ion battery (LiB), or the like, and an electrochemical capacitor (i.e., a super capacitor) are currently drawing attention as energy storage systems for an EV or HEV.

The secondary power source, such as a Li ion battery, is a representative energy storage system having high energy density. However, this secondary power source has a limited power output characteristic as compared to a super capacitor. In contrast, the super capacitor, despite its high power output, has a limitation of relatively low energy density, compared with the Li ion battery. In order to overcome such limitations, a Li pre-doping technique has been developed, and a super capacitor called a Li-ion capacitor (LiC) has already been commercialized. This Li-ion capacitor achieves an increase of three or four times in the energy density of an existing Electric Double Layer Capacitor (EDLC) type super capacitor. This improved super capacitor has recently been utilized or researched for the storage of power generated by solar energy, solar power generation, and wind power generation or as an energy source for heavy construction equipment such as an excavator, as well as an energy storage system for an electric vehicle or a hybrid electric vehicle, as stated above.

Notably, a Li pre-doping method is considered to be most important in a Li-ion capacitor. This is because the characteristics, mass-productivity and price-competitiveness of cells are determined according to how fast and how evenly Li ions are doped.

As for the Li pre-doping technique according to the related art, a conductive mesh sheet is utilized. The use of this conductive mesh sheet causes the fluidity of slurry, which makes it difficult to control the thickness of an electrode. Furthermore, an insufficient tension of the conductive mesh sheet causes difficulties in manufacturing a winding type cell.

### SUMMARY OF THE INVENTION

An aspect of the present invention provides a method of manufacturing an electrode for a secondary power source, which can simplify the manufacturing process while achieving an increase in the doping rate of Li ions by previously doping an electrode with Li ions before a cell is assembled, and a method of manufacturing a secondary power source by using the same.

An aspect of the present invention also provides an electrode for a secondary power source, which is doped evenly with a desired amount of Li ions.

According to an aspect of the present invention, there is provided a method of manufacturing an electrode for a secondary power source, the method including: forming an electrode active material on a conductive sheet; forming a lithium (Li) thin film layer by depositing Li on the electrode active material; doping the electrode active material with the deposited Li; and controlling a doping level by monitoring the doping amount of Li.

The conductive sheet may be a foil type conductive sheet.

The depositing of Li may be performed in vacuum.

The doping level may be controlled within an open-circuit potential (OCP) range of 0.1 V to 0.15 V.

In the doping of the electrode active material, the conductive sheet including the electrode active material formed thereon may be immersed in an electrolyte to thereby allow the deposited Li to infiltrate into the electrode active material.

According to another aspect of the present invention, there is provided a method of manufacturing a multilayer lithium (Li)-ion capacitor, the method including: forming an electrode active material on a conductive sheet; depositing Li on the electrode active material; doping the electrode active material with the deposited Li; controlling a doping level by monitoring the doping amount of Li to thereby form a first electrode; and sequentially stacking a separator and a second electrode on the first electrode.

According to another aspect of the present invention, there is provided a method of manufacturing a winding type lithium (Li)-ion capacitor, the method including: forming an electrode active material on a conductive sheet; depositing Li on the electrode active material; doping the electrode active material with the deposited Li; controlling a doping level by monitoring the doping amount of Li to thereby form a first electrode; and sequentially stacking a separator and a second electrode on the first electrode and winding a resultant stack.

According to another aspect of the present invention, there is provided a method of manufacturing a secondary power source, the method including: forming an electrode active material on a conductive sheet; depositing lithium (Li) on the electrode active material; doping the electrode active material with the deposited Li; controlling a doping level by monitoring the doping amount of Li to thereby form a first electrode; and placing a second electrode to oppose the first electrode with a separator interposed therebetween.

The secondary power source may be a Li-ion battery.

According to another aspect of the present invention, there is provided an electrode for a secondary power source, the electrode including: an electrode active material formed on a conductive sheet; and a lithium (Li) thin film layer formed on the electrode active material to provide Li, wherein the electrode active material is doped with the Li of the Li thin film layer.

The conductive sheet may be a foil type conductive sheet.

The electrode active material may be doped with the Li to a doping level within an open-circuit potential (OCP) range of 0.1 V to 0.15 V.

According to another aspect of the present invention, there is provided a multilayer lithium (Li)-ion capacitor including: a first electrode including an electrode active material formed on a conductive sheet and a Li thin film layer formed on the electrode active material and providing Li, wherein the electrode material is doped with the Li of the Li thin film layer; a second electrode paired with the first electrode; and a separator disposed between the first electrode and the second electrode and separating the first electrode and the second electrode from each other.

According to another aspect of the present invention, there is provided a winding type lithium (Li)-ion capacitor including: a first electrode including an electrode active material formed on a conductive sheet and a Li thin film layer formed on the electrode active material and providing Li, wherein the electrode active material is doped with the Li of the Li thin film layer; a second electrode paired with the first electrode; and a separator disposed between the first electrode and the second electrode and separating the first electrode and the second electrode from each other.

According to another aspect of the present invention, there is provided a secondary power source including: a first electrode including an electrode active material formed on a conductive sheet and a lithium (Li) thin film layer formed on the electrode active material and providing Li, wherein the electrode active material is doped with the Li of the Li thin film layer; a second electrode paired with the first electrode; and a separator disposed between the first electrode and the second electrode and separating the first electrode and the second electrode from each other.

The secondary power source may be a Li ion battery.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view illustrating a multilayer Li-ion capacitor cell;

FIGS. 2A through 2D are views illustrating the process of manufacturing a cathode of a multilayer Li-ion capacitor according to an exemplary embodiment of the present invention;

FIG. 3 is a schematic cross-sectional view illustrating a winding type Li-ion capacitor cell according to an exemplary embodiment of the present invention; and

FIG. 4 is a flowchart illustrating a method of manufacturing a cathode of a Li-ion capacitor according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Moreover, detailed descriptions related to well-known functions or configurations will be ruled out in order not to unnecessarily obscure subject matters of the present invention.

The same or equivalent elements are referred to by the same reference numerals throughout the specification.

The meaning of “include,” “comprise,” “including,” or “comprising,” comprising, specifies a property, a region, a fixed number, a step, a process, an element and/or a component but does not exclude other properties, regions, fixed numbers, steps, processes, elements and/or components.

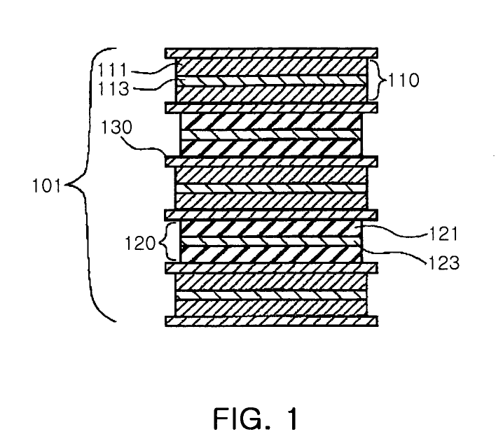

Hereinafter, a method of manufacturing an electrode for secondary powder and a method of manufacturing a secondary power source using the same, according to an exemplary embodiment of the present invention, will be described with reference to FIGS. 1 through 4.

FIG. 1 is a schematic cross-sectional view illustrating a multilayer Li-ion capacitor cell according to an exemplary embodiment of the present invention. As shown in FIG. 1, the multilayer Li-ion capacitor cell 101 includes a first electrode 110, a second electrode 120 and a separator 130.

The second electrode 120 (hereinafter, referred to as “a cathode”) is formed by applying a cathode active material layer 123 to a cathode conductive sheet 121. Although not limited thereto, the cathode active material layer 123 may utilize a material that can reversibly hold Li ions. For example, the cathode active material layer 123 may utilize a carbon material, such as graphite, hard carbon or coke, a polyacene-based material (also referred to as PAS) or the like.

Furthermore, the cathode may be formed by mixing a conductive material with the cathode active material layer 123. The conductive material, although not limited thereto, may utilize acetylene black, graphite, metal powder or the like.

A thickness of the cathode active material layer 123 is not specifically limited, but may range from 10 μm to 100 μm for example.

The conductive cathode sheet 121 serves to transfer an electrical signal to the cathode active material layer 123 and collect accumulated charges. The cathode conductive sheet 121 may be metal foil. The metal foil may be formed of stainless steel, copper, nickel, titanium or the like.

The cathode conductive sheet 121 may be a metal sheet with or without pores therein, such as a mesh type conductive sheet, a foil type conductive sheet or the like.

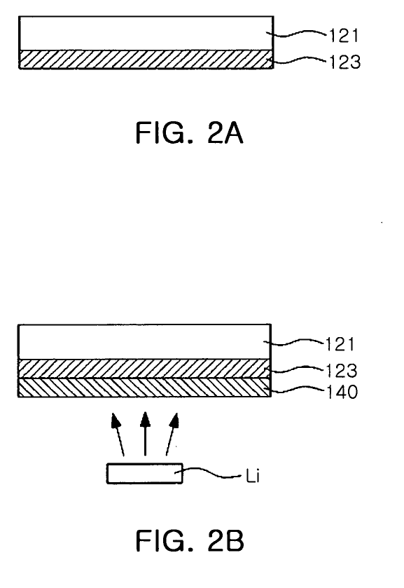

A method of manufacturing a cathode will be described in more detail with reference to FIGS. 2A through 2D.

The first electrode 110 (hereinafter, referred to as ‘an anode’) is formed by applying an anode active material layer 113 to an anode conductive sheet 111. The anode active material layer 113 may utilize a material that can reversibly hold Li ions. Although not limited thereto, the anode active material layer 113 may utilize activated carbon. In this case, an anode may be formed by mixing a conductive material and a binder with the activated carbon.

The thickness of the anode electrode material is not limited specifically, and may range from 10 μm to 400 μm for example.

The anode conductive sheet 111 serves as a conductive sheet that transfers an electrical signal to the anode active material layer 113 and collects accumulated charges. Like the cathode conductive sheet 123, the anode conductive sheet 111 may be metal foil. The metal foil may be formed of stainless steel, copper, nickel, titanium or the like.

The separator 130 may be formed of a porous material so that ions can pass through it. In this case, the porous material may be, for example, polypropylene, polyethylene, glass fiber or the like.

A single cathode 120, a single separator 130 and a single anode 110 constitute a unit cell. When a plurality of unit cells are stacked, a higher electrical capacity can be acquired.

According to the related art, after a plurality of cathodes and a plurality of anodes are stacked, the resultant stack (i.e., a multilayer cell) is impregnated with an electrolyte to thereby manufacture a capacitor. To this end, the multilayer cell needs to be provided with a separate Li metal for Li-ion doping, and a current needs to be separately applied thereto.

Hereinafter, the process of manufacturing the cathode of a Li-ion capacitor will be described with reference to FIGS. 2A through 2D.

FIG. 2A is a cross-sectional view illustrating the cathode 120 according to an exemplary embodiment of the present invention. The cathode 120 is formed by applying the cathode active material layer 123 to the cathode conductive sheet 121.

According to an exemplary embodiment of the present invention, even if a foil type conductive sheet is used as the cathode conductive sheet 121, a Li-ion capacitor with high energy density can be manufactured. In the related art, a mesh type is required for Li-ion doping happening after a cell is assembled. However, according to the exemplary embodiment of the present invention, the mesh type is not required since a Li thin film layer 140 is utilized and the Li-ion doping is thus carried out in a state of the cathode 120. According to the exemplary embodiment, Li doping can be carried out even without a mesh, due to the Li thin film layer 140 on the cathode conductive sheet 121.

Furthermore, according to the exemplary embodiment, the use of the foil type conductive sheet allows the thickness of an electrode to be easily controlled, and facilitates the manufacturing of various types of cells such as a winding type.

FIG. 2B is a schematic cross-sectional view illustrating the process of depositing the Li thin film layer 140 according to an exemplary embodiment of the present invention. In this exemplary embodiment, after the cathode active material layer 123 is applied to the cathode conductive sheet 121, Li is deposited thereon to thereby form the Li thin film layer 140.

According to the related art, the Li-ion doping is carried out by impregnating the multilayer cell with an electrolyte and separately applying electricity thereto. However, according to this exemplary embodiment, the Li thin film layer 140 is formed in advance. That is, a thin layer of Li is deposited on the cathode active material layer 123. Accordingly, the Li-ion doping can be carried out only by the impregnation of an electrolyte.

According to the related art, the multilayer cell needs to be provided with a separate Li metal layer for the Li-ion doping. However, according to this exemplary embodiment, the Li thin film layer 140 eliminates the need for the process of disposing the Li metal layer. Therefore, according to the exemplary embodiment, a dead volume, caused by the Li metal layer in the related art, is reduced, so that a reduction in the thickness of an electrode can be achieved, which allows for the miniaturization of the capacitor.

Furthermore, the amount of Li metal required for the Li-ion doping can be optimized, and the entirety of the conductive sheet can be evenly doped with Li, thereby improving the energy density and cycle characteristics of the capacitor.

The amount of Li substantially required for the Li-ion doping is very small. Therefore, a vacuum deposition method is used in order to form an appropriate amount of Li thin film layer.

FIG. 2C is a schematic view illustrating the Li-ion doping process according to an exemplary embodiment of the present invention.

As for a Li-ion capacitor according to the related art, the Li-ion doping is carried out by using electroplating. In detail, a separator is placed between a cathode and Li metal, and the resultant structure is impregnated with an electrolyte. Thereafter, doping from the metal to the cathode is induced by applying a current between the cathode and the metal.

FIG. 2C illustrates the doping process according to the exemplary embodiment. By impregnating a cathode, including Li deposited thereon, with an electrolyte, the cathode conductive sheet 121 is doped with Li ions through diffusion. The electrolyte, although not limited thereto, may utilize an electrolyte solution of a lithium salt containing an aprotic organic solvent, or the like.

Since a thin layer of Li is deposited on the cathode, the Li-ion doping may be carried out through diffusion without separately applying power thereto for example. In addition, since the Li thin film layer is deposited evenly, the cathode can be evenly doped with Li ions over its entire surface area, and the energy density and cycle characteristics can be improved accordingly.

Furthermore, a monitor unit 150 may be used to measure the amount of Li ions being doped to thereby optimize the doping amount. In order to optimize the doping amount, the monitoring operation of the monitor unit 150 may be performed such that a doping level is maintained within an Open Circuit Potential (OCP) range of 0.1 V to 0.15 V.

FIG. 2D is a schematic exploded view illustrating a unit cell 100 of a Li ion capacitor according to an exemplary embodiment of the present invention. As for the Li ion capacitor according to this exemplary embodiment, the cathode 120, the separator 130 and the anode 110 are stacked to thereby form a single unit cell 100. A plurality of unit cells 100 are stacked to thereby form a multilayer capacitor cell 101 as illustrated in FIG. 1.

In the related art, a separate doping process is required after unit cells are stacked. However, according to this exemplary embodiment, the cathode has already been doped with Li ions, and thus there is no need to impregnate the entirety of the resultant stack (i.e., a multilayer cell). Accordingly, the manufacturing process after stacking the unit cells 100 is considerably simplified.

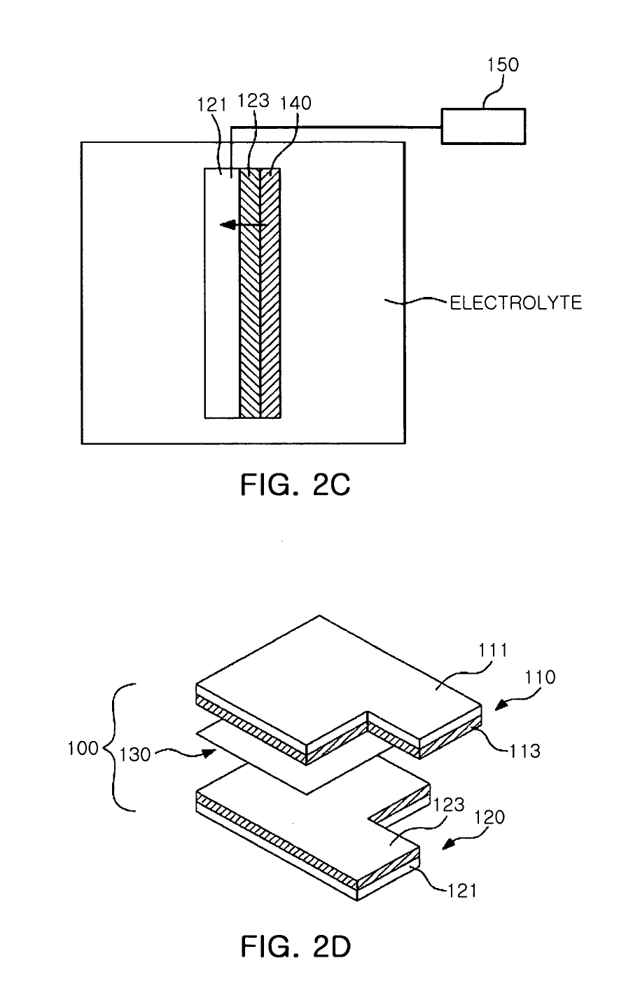

FIG. 3 is a schematic cross-sectional view illustrating a winding type Li-ion capacitor according to an exemplary embodiment of the present invention. The winding type Li-ion capacitor is formed by winding the unit cell 100 illustrated in FIG. 2D. According to this exemplary embodiment, a foil type conductive sheet and a Li thin film layer are used. Since a separate Li metal layer is not used, a thickness of an electrode becomes small and the shape thereof can be freely determined.

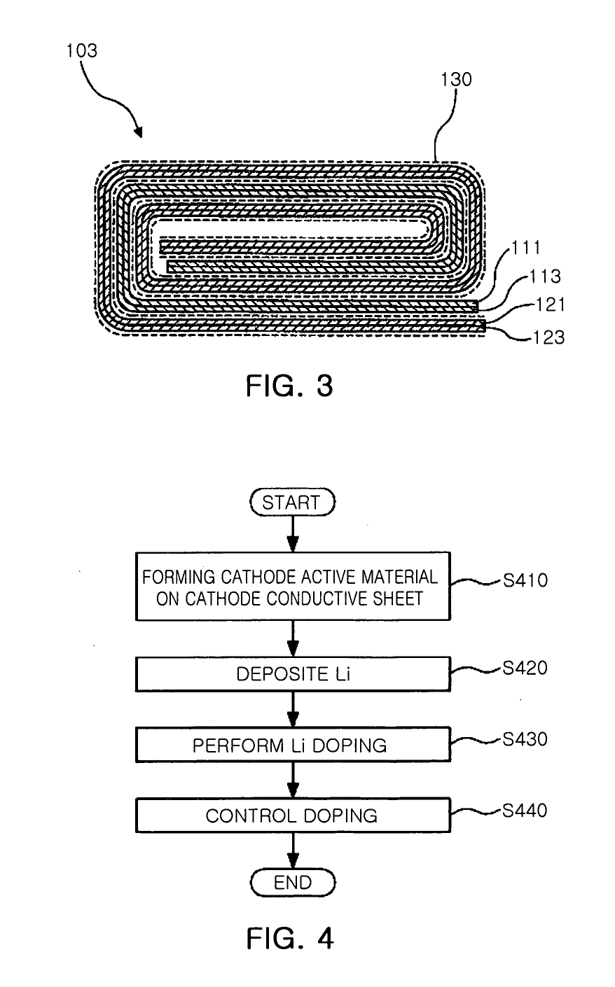

FIG. 4 is a flowchart for explaining a method of manufacturing a cathode for a Li-ion capacitor according to an exemplary embodiment of the present invention.

First, as for an electrode for a secondary power source, a cathode active material layer 123 is formed on a cathode conductive sheet 121 in operation S410. In detail, a cathode active material layer 123 that can hold Li ions is prepared, and is then applied to a mesh type conductive sheet or a foil type conductive sheet, formed of metal. In this way, a cathode 120 is prepared. The cathode conductive sheet may be manufactured by using only a foil type conductive sheet.

In operation S420, a Li thin film layer 140 is deposited on the cathode conductive sheet 121 to which the cathode active material is applied. The Li thin film layer is deposited for the Li-ion doping through diffusion. At this time, a vacuum deposition method is used in order to deposit a thin and even layer of Li. Li is deposited evenly over the cathode conductive sheet 121.

After the Li thin film layer 140 is deposited in operation S420, the cathode active material layer is doped with Li ions in operation 5430. For the Li-ion doping, the resultant structure is impregnated with an electrolyte to thereby diffuse Li ions into the cathode conductive sheet 121. In this way, the cathode is doped with Li ions. According to this exemplary embodiment, unlike the related art electroplating method, the Li-ion doping is carried out by immersing the cathode in an electrolyte without separately applying current thereto.

During the Li-ion doping S430, the doping is monitored so as to control a doping level in operation 5440. The doping level is monitored for the purpose of achieving the desired amount of doping. A doping time or the like is controlled so as to reach a desired doping level. The doping level may be controlled within an OCP range of 0.1 v to 0.15 V.

The cathode conductive sheet may be a foil type conductive type. The use of this foil type conductive sheet reduces the fluidity of slurry, thereby facilitating controlling the thickness of the electrode. Furthermore, the tension of the slurry facilitates the manufacturing of a winding type cell.

Meanwhile, an anode 110, formed by applying an anode active material layer 113 to an anode conductive sheet 111, is prepared, and a separator 130 is then prepared. The cathode 120, the separator 130 and the anode 110 are stacked to thereby form a cell. Thereafter, such cells are stacked or wound to thereby produce a multilayer capacitor cell or a winding type capacitor cell.

According to an exemplary embodiment of the present invention, a Li-ion capacitor, manufactured by a method of manufacturing a secondary power source according to an exemplary embodiment, does not employ a mesh type conductive sheet as stated above. Accordingly, various types of cells, such as winding type, can be manufactured, a reduction in dead volume can be achieved, and the Li doping can be optimized, thereby enhancing energy density and cycle characteristics. Also, since the process of inserting Li foil is not necessary, a cell structure can be stabilized and simplified.

A Li-ion capacitor is described for the secondary power source according to this exemplary embodiment of the present invention. However, this is merely an example, and the technical aspect of the present invention may be applied to another kind of secondary power source. The secondary power source may be a Li-ion battery or the like.

According to another exemplary embodiment of the present invention, a Li-ion battery may be manufactured by using the above-described electrode manufacturing method. The Li-ion battery is formed by placing the first electrode and the second electrode so as to interpose the separator therebetween. According to the related art, the Li pre-doping process is not compatible with the active manufacturing process, and is thus not adopted. However, according to the exemplary embodiment of the present invention, the Li pre-doping technique is applicable to the LiB manufacturing process as an addition process and is capable of enhancing the performance of a cathode. The Li pre-doping technique can prevent the loss of Li by preventing the formation of a solid electrolyte interface (SEI) in a cathode material at an early stage, and maximize output characteristics by maximally utilizing a cathode with a wide specific surface area.

As set forth above, according to exemplary embodiments of the invention, a method of manufacturing an electrode for a secondary power source allows for the doping quantity to be controlled to an optimum level and simplifies a doping process. Furthermore, since a vacuum deposition method is used, Li can be evenly deposited, and a doping process can be simplified. Namely, the Li doping rate and the evenness of Li doping can be significantly enhanced.

The electrode for a secondary power source, according to exemplary embodiments of the present invention, is suitable to manufacture various types of cells such as winding type or the like. Also, a cell is doped with Li to a desired extent, thereby optimizing cell performance.

Therefore, the secondary power source according to exemplary embodiments of the present invention can have enhanced output characteristic or energy density.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of manufacturing an electrode for a secondary power source, the method comprising:
forming an electrode active material on a conductive sheet;
forming a Li thin film layer by depositing lithium (Li) on the electrode active material;
doping the electrode active material with the deposited Li; and
controlling a doping level by monitoring the doping amount of Li.

2. The method of claim 1, wherein the conductive sheet is a foil type conductive sheet.

3. The method of claim 1, wherein the depositing of Li is performed in vacuum.

4. The method of claim 1, wherein the doping level is controlled within an open-circuit potential (OCP) range of 0.1 V to 0.15 V.

5. The method of claim 1, wherein, in the doping of the electrode active material, the conductive sheet including the electrode active material formed thereon is immersed in an electrolyte to thereby allow the deposited Li to infiltrate into the electrode active material.

6. A method of manufacturing a multilayer lithium (Li)-ion capacitor, the method comprising:
forming an electrode active material on a conductive sheet;
depositing Li on the electrode active material;
doping the electrode active material with the deposited Li;
controlling a doping level by monitoring the doping amount of Li to thereby form a first electrode; and
sequentially stacking a separator and a second electrode on the first electrode.

7. A method of manufacturing a winding type lithium (Li)-ion capacitor, the method comprising:
forming an electrode active material on a conductive sheet;
depositing Li on the electrode active material;
doping the electrode active material with the deposited Li;
controlling a doping level by monitoring the doping amount of Li to thereby form a first electrode; and
sequentially stacking a separator and a second electrode on the first electrode and winding a resultant stack.

8. A method of manufacturing a secondary power source, the method comprising:
forming an electrode active material on a conductive sheet;
depositing lithium (Li) on the electrode active material;
doping the electrode active material with the deposited Li;
controlling a doping level by monitoring the doping amount of Li to thereby form a first electrode; and
placing a second electrode to oppose the first electrode with a separator interposed therebetween.

9. The method of claim 8, wherein the secondary power source is a Li-ion battery.

10. An electrode for a secondary power source, the electrode comprising:
an electrode active material formed on a conductive sheet; and
a lithium (Li) thin film layer formed on the electrode active material to provide Li,
wherein the electrode active material is doped with the Li of the Li thin film layer.

11. The electrode of claim 10, wherein the conductive sheet is a foil type conductive sheet.

12. The electrode of claim 10, wherein the electrode active material is doped with the Li to a doping level within an open-circuit potential (OCP) range of 0.1 V to 0.15 V.

13. A multilayer lithium (Li)-ion capacitor comprising:
a first electrode including an electrode active material formed on a conductive sheet and a Li thin film layer formed on the electrode active material and providing Li, wherein the electrode material is doped with the Li of the Li thin film layer;
a second electrode paired with the first electrode; and
a separator disposed between the first electrode and the second electrode and separating the first electrode and the second electrode from each other.

14. A winding type lithium (Li)-ion capacitor comprising:
a first electrode including an electrode active material formed on a conductive sheet and a Li thin film layer formed on the electrode active material and providing Li, wherein the electrode active material is doped with the Li of the Li thin film layer;
a second electrode paired with the first electrode; and
a separator disposed between the first electrode and the second electrode and separating the first electrode and the second electrode from each other.

15. A secondary power source comprising:
a first electrode including an electrode active material formed on a conductive sheet and a lithium (Li) thin film layer formed on the electrode active material and providing Li, wherein the electrode active material is doped with the Li of the Li thin film layer;
a second electrode paired with the first electrode; and
a separator disposed between the first electrode and the second electrode and separating the first electrode and the second electrode from each other.

16. The secondary power source of claim 15, wherein the secondary power source is a Li ion battery.
